(19) United States
(12) Patent Application Publication
(10) Pub. No.: US 2018/0056530 A1
(43) Pub. Date: Mar. 1, 2018

(54) Knife

(71) Applicant: Chia-Ming Liu, Douliou City (TW)

(72) Inventor: Chia-Ming Liu, Douliou City (TW)

(21) Appl. No.: 15/364,640

(22) Filed: Nov. 30, 2016

(30) Foreign Application Priority Data
Aug. 29, 2016 (CN) 201620963599.3

(51) Int. Cl. B26B 3/00; B25G 1/00

(52) U.S. Cl. CPC B26B 3/00; B25G 1/00

(57) ABSTRACT

A knife includes a hollow handle, a blade and a counterweight unit. The hollow handle extends along an axis and has opposite front and rear ends along the axis. The blade is connected to the front end of the handle. The counterweight unit is disposed in the handle, and includes a rail and a counterweight. The rail extends along the axis. The counterweight is connected to and movable along the rail.

### CROSS-REFERENCE TO RELATED APPLICATION

This application claims priority of Chinese Patent Application No. 201620963599.3, filed on Aug. 29, 2016.

### FIELD

The disclosure relates to a knife, and more particularly to a knife with a movable counterweight.

### BACKGROUND

A conventional knife is usually manufactured with a fixed weight distribution. However, after long-term use, and after being repeatedly sharpened, the center of gravity of the conventional knife will move rearwardly, thereby affecting comfort of use and manipulation of the conventional knife.

### SUMMARY

Therefore, an object of the disclosure is to provide a knife that can alleviate at least one of the drawbacks of the prior art.

The knife includes a hollow handle, a blade and a counterweight unit. The hollow handle extends along an axis and has opposite front and rear ends along the axis. The blade is connected to the front end of the handle. The counterweight unit is disposed in the handle, and includes a rail and a counterweight. The rail extends along the axis. The counterweight is connected to and movable along the rail.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view illustrating an embodiment of a knife according to the disclosure;

FIG. 2 is a perspective view of the embodiment;

FIG. 3 is a sectional view of the embodiment; and

FIG. 4 is a view similar to FIG. 3, but illustrating a counterweight being moved along a rail to another position.

### DETAILED DESCRIPTION

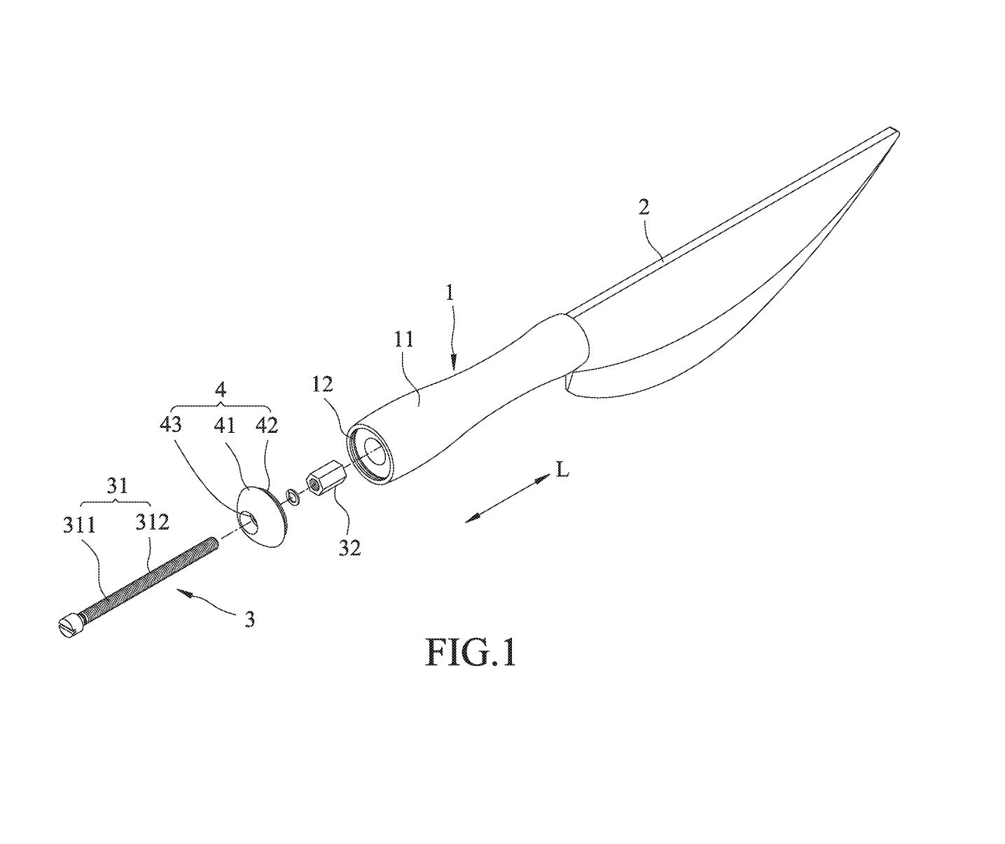

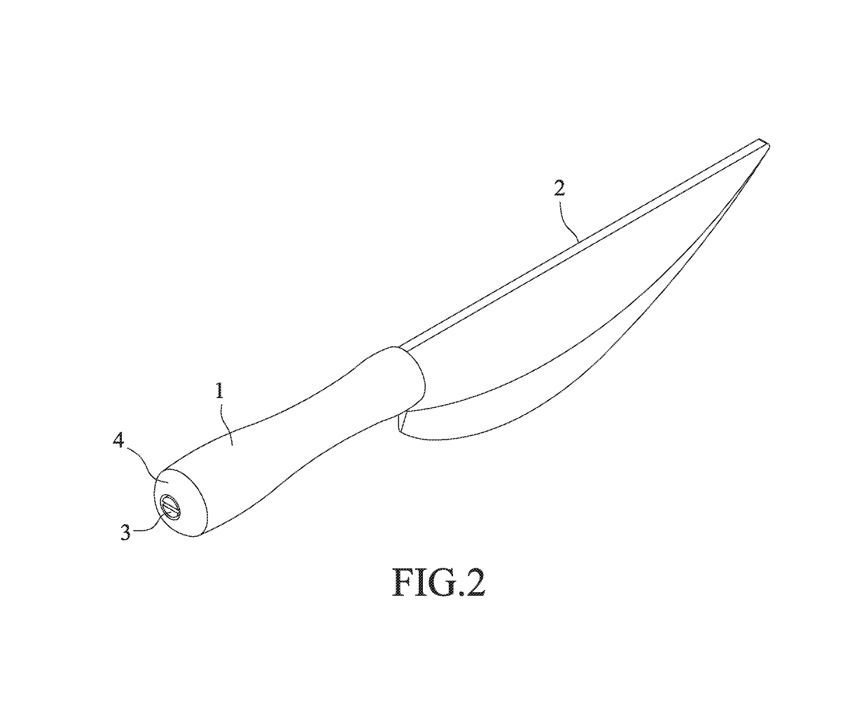

Referring to FIGS. 1 to 4, an embodiment of a knife according to the disclosure is illustrated. The knife includes a hollow handle 1, a blade 2, a counterweight unit 3 and a rear cover 4. The handle 1 extends along an axis (L) and has opposite front and rear ends along the axis (L). The blade 2 is connected to the front end of the handle 1. The counterweight unit 3 is disposed in the handle 1. The rear cover 4 is removably connected to the rear end of the handle 1.

The handle 1 has a handle body 11. The handle body 11 has an inner surrounding surface that defines a receiving channel 111 extending along the axis (L), and an internal thread 12 that is formed on the inner surrounding surface at a position distal from the blade 2.

The counterweight unit 3 includes a rail 31 and a counterweight 32. The rail 31 is disposed in the receiving channel 111 and connected to the rear cover 4. In this embodiment, the rail 31 has a main body 311 that extends along the axis (L), and an outer thread 312 that is formed on an external surface of the main body 311. The counterweight 32 is a nut engaged movably with the outer thread 312 of the rail 31 and is movable along the rail 31.

The rear cover 4 has a body portion 41, and an external thread 42 formed on an external surface of the body portion 41 and engaged removably with the internal thread 12 of the handle 1. Moreover, the body portion 41 of the rear cover 4 is hollow, and has an internal surrounding surface formed with an internal thread 43. By virtue of the threaded engagement between the outer thread 312 of the rail 31 and the internal thread 43 of the rear cover 4, the rail 31 is removably engaged with the body portion 41 of the rear cover 4.

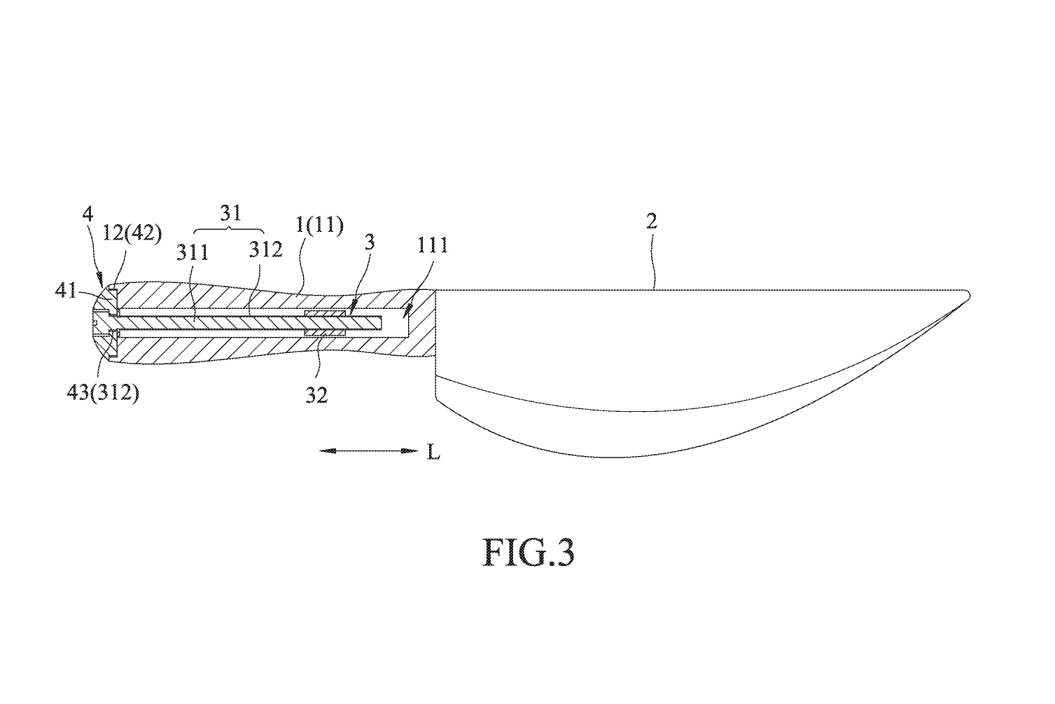

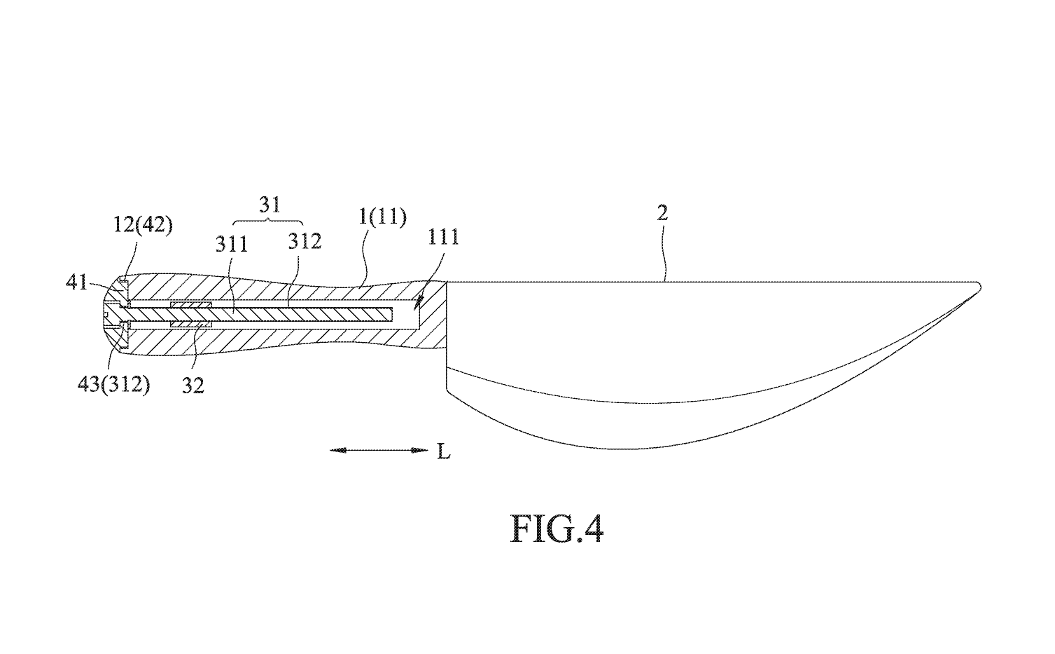

After being used for a long period of time, the knife may have issues of varied weight distribution due to abrasion. To alleviate the issue, a user of the knife may separate from the handle body 11 the rear cover 4 accompanied by the rail 31 and the counterweight 32, move the counterweight 32 forwardly from one position (see FIG. 4) to another position (see FIG. 3) along the rail 31 according to personal preference, and reassemble the rear cover 4, the rail 31 and the counterweight 32 back to the handle body 11. Therefore, weight distribution of the knife is adjusted.

It is worth noting that the handle may be implemented to have an opening formed on the handle body 11 and extending along the axis (L) so as to expose the rail 31 and the counterweight 32 to the external environment. As a result, the user can conveniently move the counterweight 32 without separating the rail 31 and the counterweight 32 from the handle body 11.

As long as the counterweight 32 can be moved along the axis (L) on the rail 31 and is disposed in the receiving channel 111 of the handle 1, the user is able to adjust the weight distribution of the knife to improve the comfort of use and the manipulation of the knife. Therefore, the rail 31 may be implemented, in other embodiments, with a front end thereof being at a front end of the receiving channel 111 and being connected to a front end portion of the handle 1, and should not be limited to the embodiments of this disclosure.

In summary, the disclosure has the following advantages. First, the weight distribution of the knife can be adjusted by moving the counterweight 32 along the rail 31 so as to improve the comfort of use and the manipulation of the knife. Second, the structure of the knife of this disclosure is simple and assembly of the knife is convenient.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A knife comprising:
a hollow handle extending along an axis and having opposite front and rear ends along the axis;
a blade connected to said front end of said handle; and
a counterweight unit disposed in said handle, and including
a rail that extends along the axis, and
a counterweight that is connected to and movable along said rail.

2. The knife as claimed in claim 1, further comprising a rear cover removably connected to said rear end of said handle, said handle having a handle body that defines a receiving channel extending along the axis, said rail being disposed in said receiving channel and connected to said rear cover.

3. The knife as claimed in claim 2, wherein:
said handle body has an inner surrounding surface defining said receiving channel, and an internal thread formed on said inner surrounding surface;
said rear cover has a body portion and an external thread formed on an external surface of said body portion and engaged removably with said internal thread of said handle;
said rail of said counterweight unit has a main body that extends along the axis, and an outer thread that is formed on an external surface of said main body; and
said counterweight is a nut engaged movably with said outer thread of said rail.

4. The knife as claimed in claim 3, wherein said body portion of said rear cover is hollow, and has an internal surrounding surface formed with an internal thread, said rail being removably and threadedly engaged with said body portion of said rear cover.
